(19) United States
(12) Patent Application Publication
(10) Pub. No.: US 2007/0221802 A1
(43) Pub. Date: Sep. 27, 2007

(54) Ladder tray and method of attachment therefor

(76) Inventors: Donald Arlen New SR., Eagar, AZ (US); Levana Fraval, Eagar, AZ (US); Hanafi R. Fraval, Eagar, AZ (US); John C. Donachy, Laveen, AZ (US); Jonathan S. Ash, Pittsford, NY (US); Raymond S. Zuckerman, Scottsdale, AZ (US); Jack P. Durban, Mission Viejo, CA (US)

Correspondence Address: WEISS & MOY PC, 4204 NORTH BROWN AVENUE, SCOTTSDALE, AZ, 85251, US

(21) Appl. No.: 11/549,099

(22) Filed: Oct. 12, 2006

Related U.S. Application Data
(60) Provisional application No. 60/752,219, filed on Dec. 20, 2005.

(51) Int. Cl. E06C 7/14

(52) U.S. Cl. 248/210

(57) ABSTRACT

Provided is an apparatus comprising a tray assembly and a wedge rod assembly. The tray assembly includes a roughly-cylindrical paint well, tool orifices, and a handle for one-handed carrying, adjusting, and moving the tray. A button is provided on the handle to allow detachment of the tray from a ladder without the need for two handed operation. A locking or wedge rod assembly is provided for securely interfacing the tray assembly to a hollow-rung ladder. By rotating a grip on the wedge rod assembly, a top platform on the wedge rod assembly extends vertically to engage the interior surfaces of a rung of the ladder, and thereby locks the wedge rod into place. The tray assembly may then be adjusted to the desired angle and attached to the locked wedge rod assembly by engaging the coupling areas. Depressing a button on the handle of the tray assembly releases the tray from the wedge rod assembly and ladder.

### CROSS REFERENCES TO RELATED APPLICATIONS

This application claims the full benefit and priority of U.S. Provisional Application Ser. No. 60/752,219, filed on Dec. 20, 2005, the disclosure of which is fully incorporated by reference herein for all purposes.

### BACKGROUND

1. Field of the Invention

The present invention relates generally to the storage and use of tools, paints, and supplies and their accessories, and more particularly, to mechanisms that attach to ladders to provide ready access to tools, paint, and supplies.

2. Description of the Related Art

Ladders are frequently used by many construction and maintenance trades such as carpenters, painters, electricians and the like, and have been in use for hundreds of years. Commonly, ladder users have either donned tool belts to temporarily store tools or supplies or have utilized steps or crude mechanisms built into ladders to provide tool or paint bucket support. Once the worker is in position on the ladder, placing paint buckets, tools, or supplies is often a dangerous juggling act, as many of the rudimentary tool or paint holders integrated in prior art ladders provide at best a limited and unsecured support for a paint bucket or at most a few tools. The hazards that arise from attempting to use unsecured tools, supplies and paint while on an upper portion of a ladder are obvious; the worker is encumbered while attempting to maintain balance and select the appropriate tool, and the risks of tools falling are increased. Tool belts provide only limited utility as often the worker must reach awkwardly around to gain access to a specific tool, and by taking his eyes from the work to look at the tool belt by his side, loss of balance is increased. Likewise, the current placement of paint buckets or cans on ladders leaves much to be desired from efficiency and safety aspects, as painters must often awkwardly reach into buckets to access lower paint levels, and many paint shelves on some ladders has led to many dropped cans in the past.

Some approaches to solve the problem have been undertaken, such as hooks or other contrivances to attach paint cans and/or tools to a ladder, but many of these suffer from a limited ability to easily place or secure the tools and/or paint, and further suffer from a lack of practical means to convey paint and/or tools such as brushes and scrapers up and down a ladder or from side to side while allowing for ease of attachment/detachment, handy working space, ready access to a variety of tool holders, and minimized impact on encumbrance.

Modern ladders are often constructed of hollow, horizontal D-shaped rungs that pass through the two ladder stiles (or vertical legs), leaving the rungs open on either side. Some prior approaches have used bars or hooks to secure a paint bucket to horizontal ladder rungs, and have espoused the virtues of allowing either the bucket or rod or other attachment devices to auto-level the paint bucket with respect to vertical, regardless of the inclination of the ladder. However, as those of skill in the art understand, as the paint level in a paint bucket diminishes, the painter experiences increasing difficulty in visually determining the current paint level in a vertically-disposed bucket, and upon dipping a brush or other painting tool, may obtain too much or too little paint. Likewise, since self-leveling devices do not provide for the bucket to be tipped except by use of a person's free hand, paint may be wasted at the bottom of the bucket as the bucket nears an empty state. Further, most of the prior approaches may either have an unsecured connection between the paint bucket and the securing means (such as by a simple insertion of a bar into a ladder rung's internal space) or a difficult to reposition locking means to secure the paint bucket to the ladder.

What is needed, therefore, is a tray assembly that can be used with common, commercially-available ladders. What is also needed is a tray assembly that can be carried, attached to a ladder, and detached with one hand. What is also needed is a device to provide for a detachable tray assembly to allow paint buckets and related appliances and tools to be easily conveyed up and down a ladder, and secured thereto. What is also needed is a method of attaching a tray to a ladder that provides for a secure fit while minimizing the dexterity needed to secure and remove the tray.

### SUMMARY

It is an object of the present invention to overcome various problems associated with the prior art. In view of the forgoing, it is an object of the present invention to provide an apparatus, that comprises a tray assembly and a wedge rod assembly. The tray assembly, also called a utility tray, comprises a roughly-cylindrical paint well (or bucket holder), tool holders (or orifices), and a handle for one-handed carrying, adjusting, and moving the tray. A button is provided on the handle to allow detachment of the tray from a ladder without the need for two-handed operation. A locking or wedge rod assembly is provided for securely interfacing the tray assembly to a hollow-rung ladder. By rotating a grip on the wedge rod assembly, a top platform on the wedge rod assembly extends vertically to engage the interior surfaces of a rung of the ladder, and thereby locks the wedge rod into place. The tray assembly may then be adjusted to the desired angle and attached to the locked wedge rod assembly by pushing the tray's handle assembly into the coupling area or mating cavity of the wedge rod assembly. Depressing a button on the handle of the tray assembly releases the tray from the wedge rod assembly and ladder, and by pulling the tray assembly outwardly from the wedge rod assembly, the tray is cleared and may be moved or re-attached. The button may also be depressed and the tray partially removed and rotated before re-attaching to adjust the angle of the tray for ease of use or more effective painting. Further, the wire bail of a paint can may be placed on a catch, such as a hook provided on a truss support located beneath the tray assembly, thereby allowing single-handed carrying of both the tray assembly and a can of paint. Placement of the hook is selected to couple the paint can's weight through the handle balance point of the tray assembly. Those of skill in the art also recognize that the hook may hold one paint can while a second paint can is supported in the paint well; such configuration provides a means to substitute paint cans, to change colors, or to keep painting when one can runs dry. The can hanging from the hook may also be interfaced to a suction hose, such as used on a sprayer or power roller.

### BRIEF DESCRIPTION OF THE DRAWINGS

FIG. 1 depicts a view of an apparatus of the present invention installed in a ladder;

FIG. 2 illustrates a close-up view of an apparatus of the present invention installed in the rung of a ladder;

FIG. 3 depicts an apparatus of the present invention not installed in a ladder;

FIG. 4 illustrates a tray assembly of the present invention as detached from a wedge rod assembly of the present invention, the wedge rod being installed in the rung of a ladder;

FIG. 5 shows a partial cutaway of the tray assembly of the present invention, illustrating a truss and T-bar assembly;

FIG. 6 shows another partial cutaway of the tray assembly of the present invention, illustrating a truss in perspective view;

FIG. 6A illustrates a cross sectional view of the apparatus of the present invention installed in a rung of a ladder, also shown in cross section;

FIG. 7 illustrates one embodiment of a partial tray assembly, wherein a handle assembly is shown separated from a support platform;

FIG. 8 shows an alternate view of a handle assembly of the present invention that illustrates coupling mechanisms;

FIG. 9 shows a cross-sectional view of the wedge rod assembly of the present invention;

FIG. 9A shows an assembled wedge rod assembly of the present invention;

FIG. 9B illustrates a cross section of a wedge rod assembly while installed in a ladder rung, the wedge rod assembly not fully engaged with the ladder rung interior surface;

FIG. 9C illustrates a cross section of a wedge rod assembly while installed in a ladder rung, the wedge rod assembly engaged with the ladder rung interior surface;

FIG. 10 shows a cross section of a handle assembly of the present invention, illustrating the latching and coupling mechanism;

FIG. 11 shows an exploded partially assembled wedge rod assembly, illustrating a coupling nut housing;

FIG. 12 illustrates a flowchart of a method of the present invention for installation of a ladder tray; and,

FIG. 13 illustrates a flowchart of a method of the present invention for adjustment or removal of a ladder tray.

The same numbers are used throughout the disclosure and figures to reference like components and features.

### DETAILED DESCRIPTION

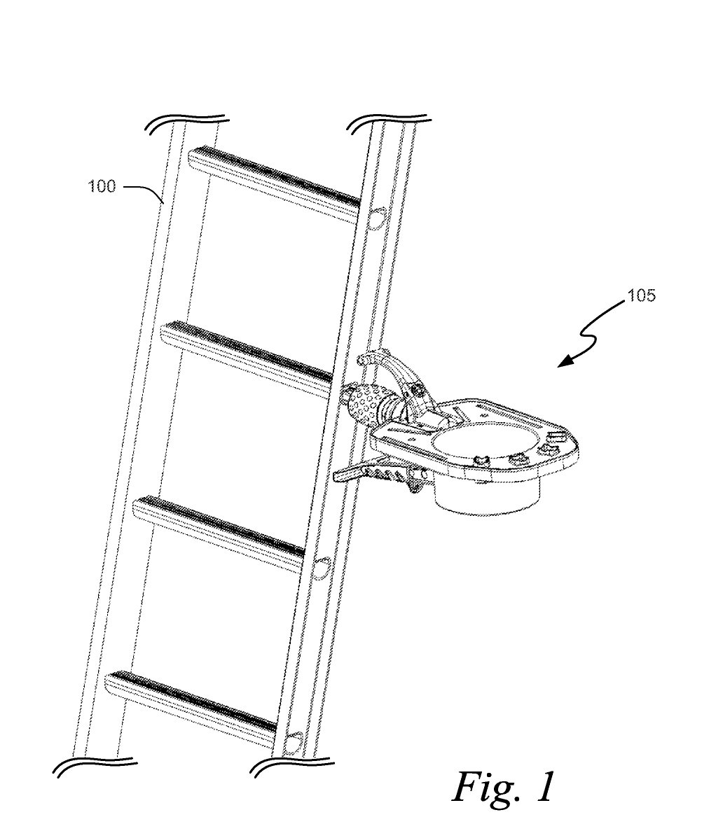

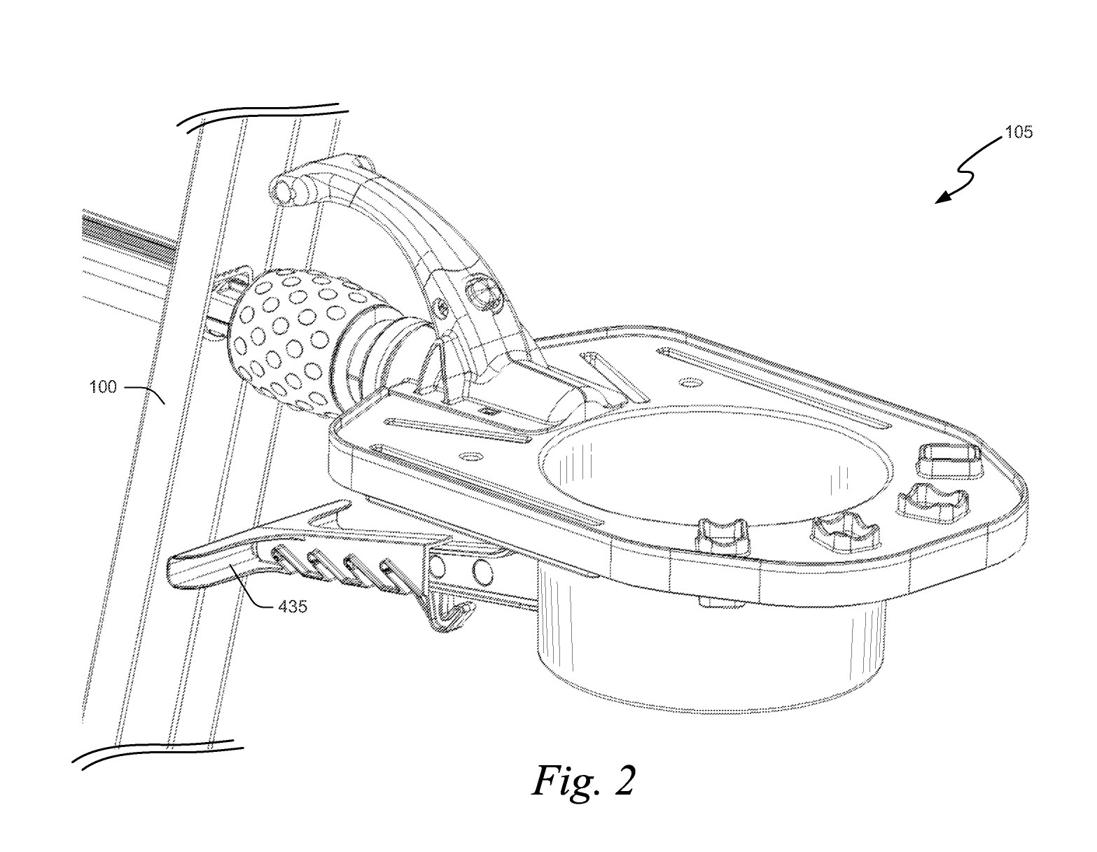

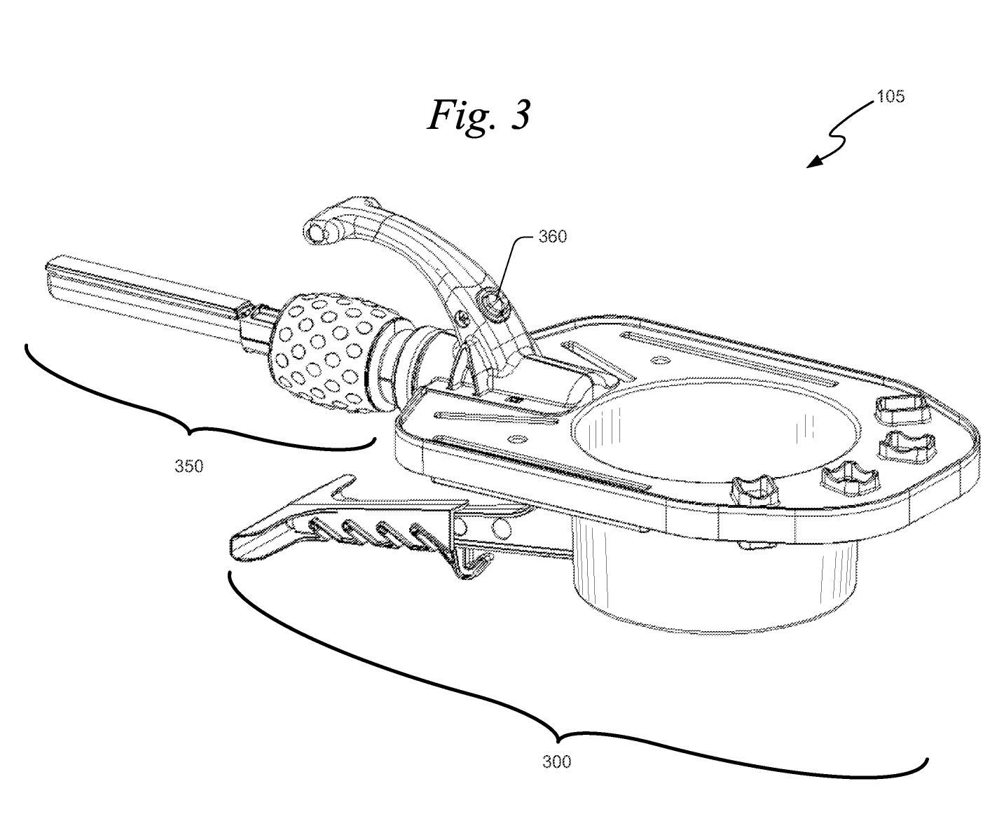

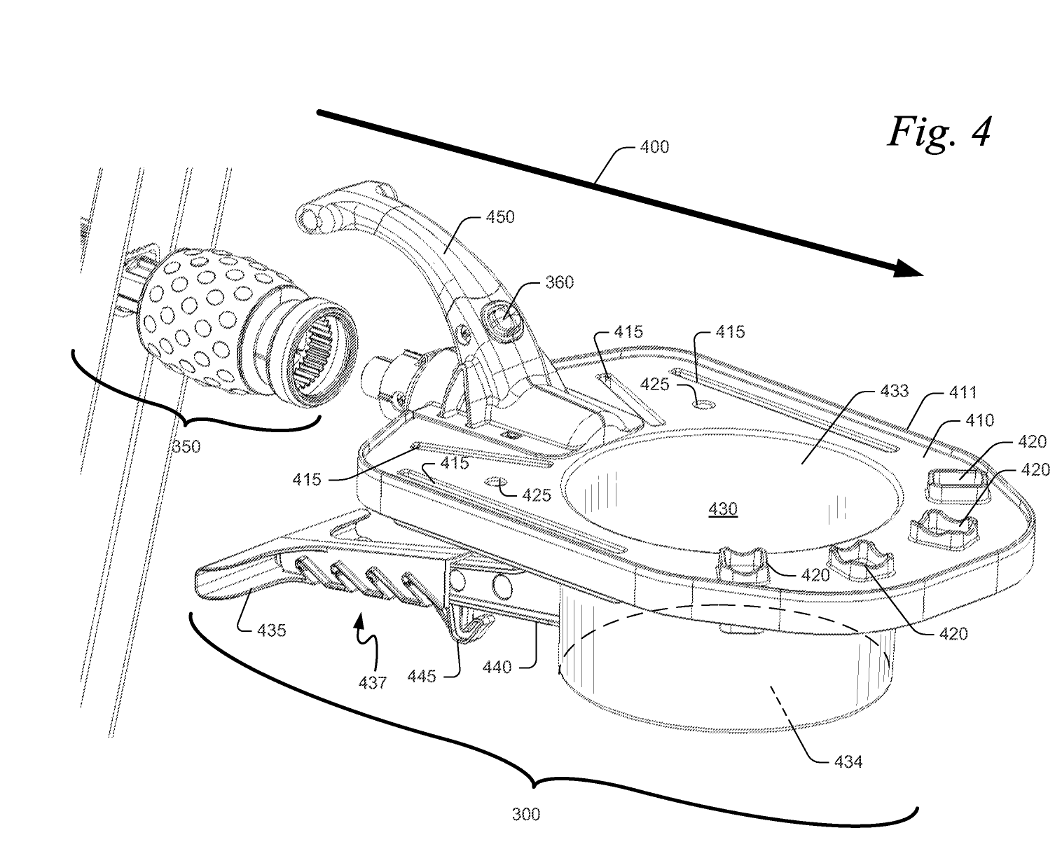

As a general overview, turning to FIG. 1, a hollow-rung ladder 100 is shown along with an attached embodiment of the apparatus of the present invention 105 (shown in close up view in FIG. 2). Although shown on the right side of the ladder 100, the present invention may be installed on either side where an open rung is available. FIG. 3 illustrates apparatus 105 with the ladder 100 removed from view for ease of illustration. Apparatus 105 comprises two major subassemblies: a tray assembly 300, and a wedge rod assembly 350 that in one embodiment, comprises a cantilever. A release button 360, when depressed, releases a latch (discussed in more detail below) that allows the tray assembly 300 to detach from wedge rod assembly 350 as shown 400 in FIG. 4. Those of skill in the art understand that the major and minor structural components of the apparatus 105 may be fabricated from polymers, metals, wood or wood composites, glass-filled nylon, or any combination of the above.

Referring to FIG. 4, in the illustrated embodiment, tray assembly 300 comprises a support platform 410 for holding paint cans, paint brushes, paint scrapers, and related tools. It is understood by those of skill in the art that other tray configurations may be utilized to provide storage for tools and working supplies other than paint, such as a tool tray that provides containers for electrical connectors, screws, nuts, nails, and the like. The support platform 410 further comprises a lip 411 that is attached to the support platform at its outer perimeter. The lip 411 adds mechanical strength and rigidity, and assists with retaining paint and loose objects on the surface of the support platform. Tray assembly 300 comprises one or more tool storage orifices (415, 420, 425) through which narrow portions of many types of tools may be passed, thus securing tools for ready use and availability. For example, wider-bladed tools such as putty knifes and paint scrapers may be stored by placing their blades through slots 415, screwdrivers and the like may be placed shaft-down in narrower holes 425, and paint brushes or wire brushes may be placed handle-down in brush holders 420. Those of skill in the art may appreciate that having the handle down on a paint brush reduces the amount of deformation of brush bristles that may occur by passing the brush bristles through a confined space, and further prevents paint drippings from wet brushes from falling to the ground below. Tray assembly 300 further comprises a paint well 430. The paint well 430 is a approximately cylindrical-shaped bucket whose top defines opening in the tray, and having a closed, attached bottom 434. The cylindrical wall 433 of the paint well 430 may be orthogonal with respect to the support platform 410, or may comprise a taper such that the inside diameter of the paint well at the bottom 434 is less than the top opening diameter. The paint well 430 may be integrally molded into the platform 410 or may be bonded or connected to the platform. The diameter of the well 430 is sized to accommodate gallon cans of paint, but those of skill in the art recognize that such paint well may be sized larger or smaller to accommodate desired shapes or sizes of paint or liquid containers. In one embodiment, for example, paint well 430 may comprise a rectanguloid-shaped well, to accommodate gallon paint containers that comprise rectanguloid rather than cylindrical shapes. In yet another embodiment, the tray assembly 300 may comprise a plurality of paint wells to accommodate a number of smaller paint cans, such as would be needed when painting multi-colored surfaces.

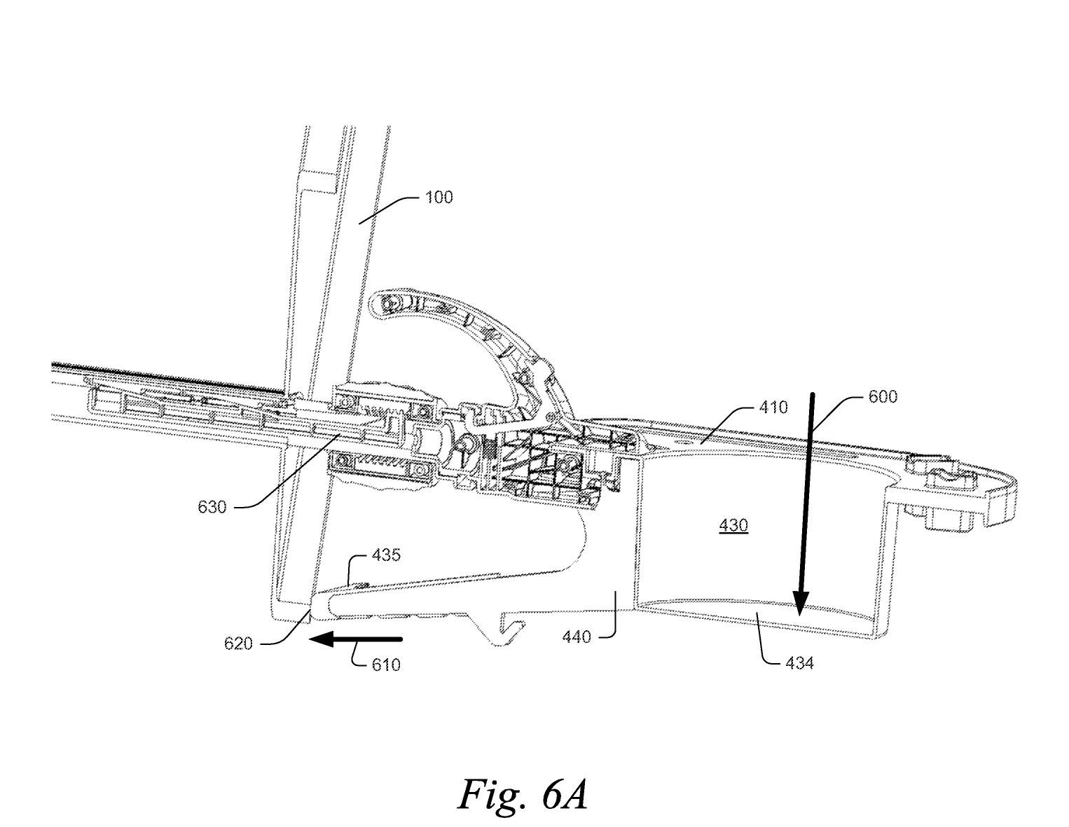

Tray assembly 300 further comprises a truss 440, with a repositionable T-bar 435. Among other purposes, the truss provides additional support to counteract heavy loads such as a large can of paint in the paint well 430, by distributing the load onto the stile of the ladder 100 by contact of T-bar 435 (see FIG. 2), and thereby reducing the bending moment applied to the interface of the tray assembly 300 and wedge rod assembly 350. FIG. 6A also illustrates the load distribution features of the truss 400 and T-bar 435. Without the truss 440, when load 600 is applied to the tray assembly when attached to the wedge bar assembly, a significant bending force may be created at the interface 630 with the ladder 100. However, with the truss 440 and T-bar 435 adjusted to contact the ladder 100 at point 620, the bending force is mitigated by a lateral force applied to the ladder stile.

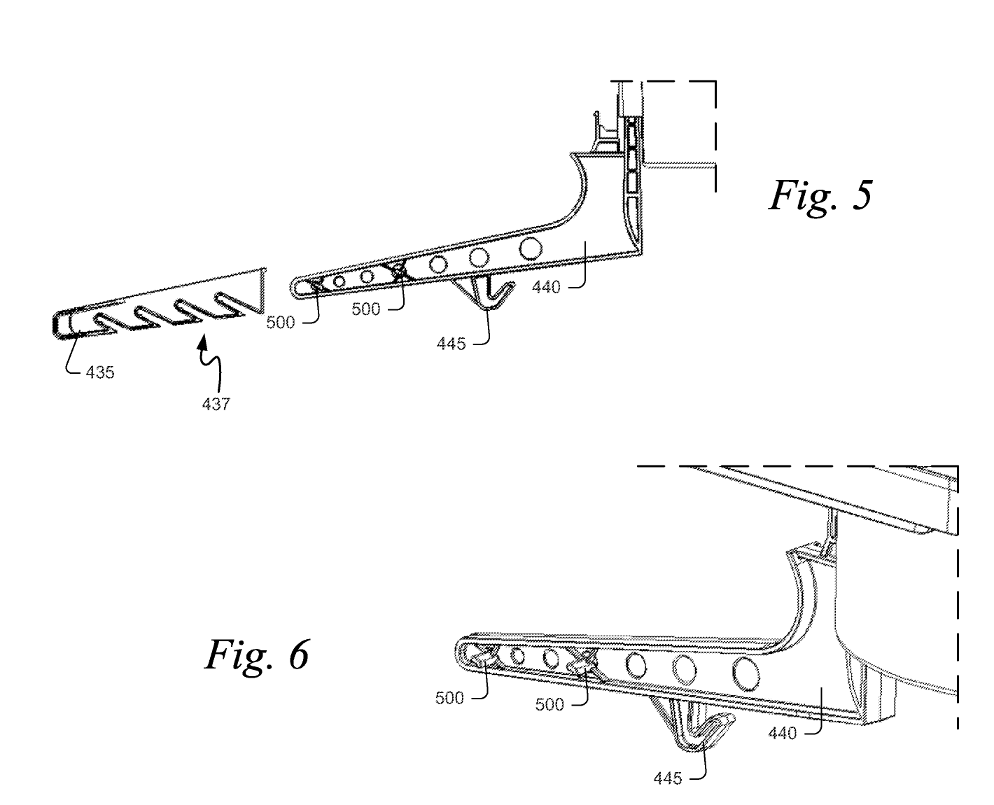

The T-bar 435 comprises diagonally disposed grooves 437 that engage pins 500 (see FIGS. 5 and 6). The pins 500 are approximately orthogonally disposed with respect to the major axis of the truss 440, and each pin has an identical counterpart protruding from the opposite side of the truss (not shown). The plurality of grooves 437 allows multiple alignment configurations with pins 500. By selecting different pin to groove combinations, the distance from the paint well 430 to the T-bar 435 may be varied, and therefore the placement of the T-bar 435 on the truss 440 may be adjusted to accommodate varying ladder designs. T-bar 435 also comprises a catch such as a paint hook 445, that provides a carry location onto which a bail wire of traditional paint cans may be connected. In this manner, the detached tray assembly 300 and a can of paint may be carried by holding the handle 450 with the tray assembly balanced in a more horizontal configuration. In the alternative, a spare paint can may be stored while another can resides in the paint well 430.

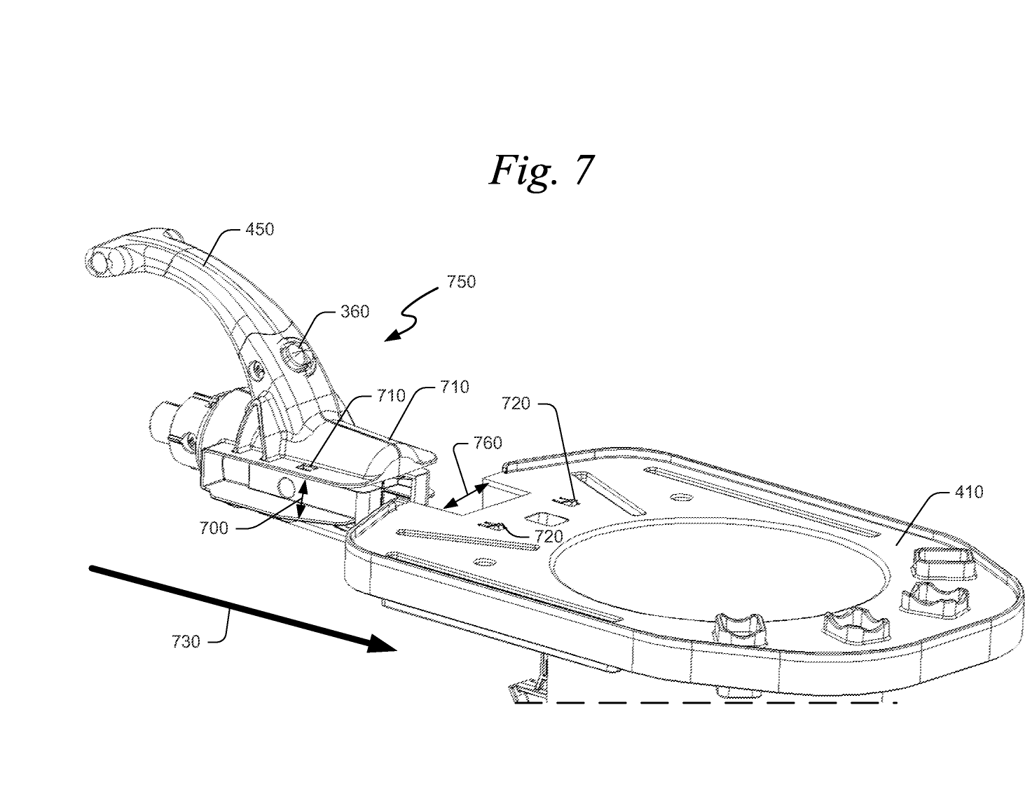

Turning to FIG. 7, the tray assembly 300 also comprises a handle assembly 750 with an integral handle 450 and release button 360. The handle assembly 750 provides an accessible means to grasp and carry the tray assembly, and provides the mechanical interface between the support platform 410 and the wedge rod assembly 350. In the embodiment shown in FIG. 7, the handle assembly comprises flange space 700 defined by an upper flange and lower flange that pass over and mate with the support platform 410 (shown fully engaged in FIGS. 3 and 4) proximally to the handle gap 760. As handle assembly 750 is moved in toward 730 the support platform 410, the flanges engage the top and bottom surfaces of the support platform 410, the handle assembly 750 registers with the handle gap 760, detent snap retainers 720 are biased downward by bending force applied by contact with the top flanges, and when the handle assembly 750 is moved fully to nest between the flange space 700 and the handle gap 760, detent snap retainers 720 then snap up into detent spaces 710 to secure the handle assembly 750 to the support platform 410. The handle assembly may be released by depressing the tops of detent snap retainers 720 through the detent spaces 710 and then moving the handle the opposite respective direction to that described above, allowing interchangeability of handle assemblies with a variety of support platforms 410.

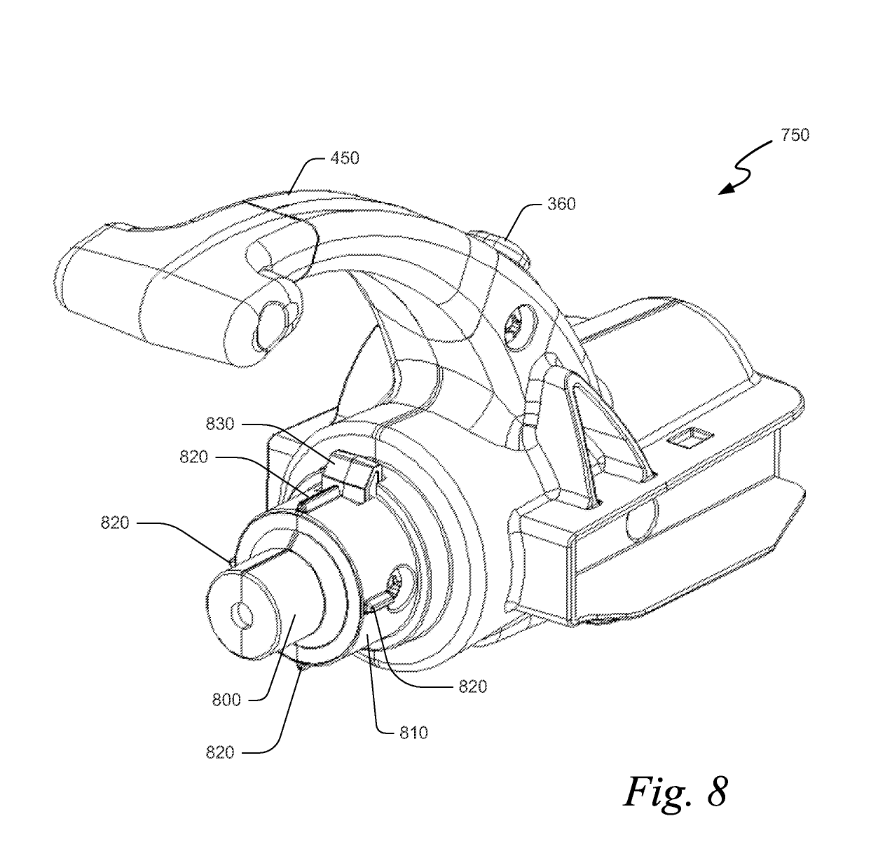

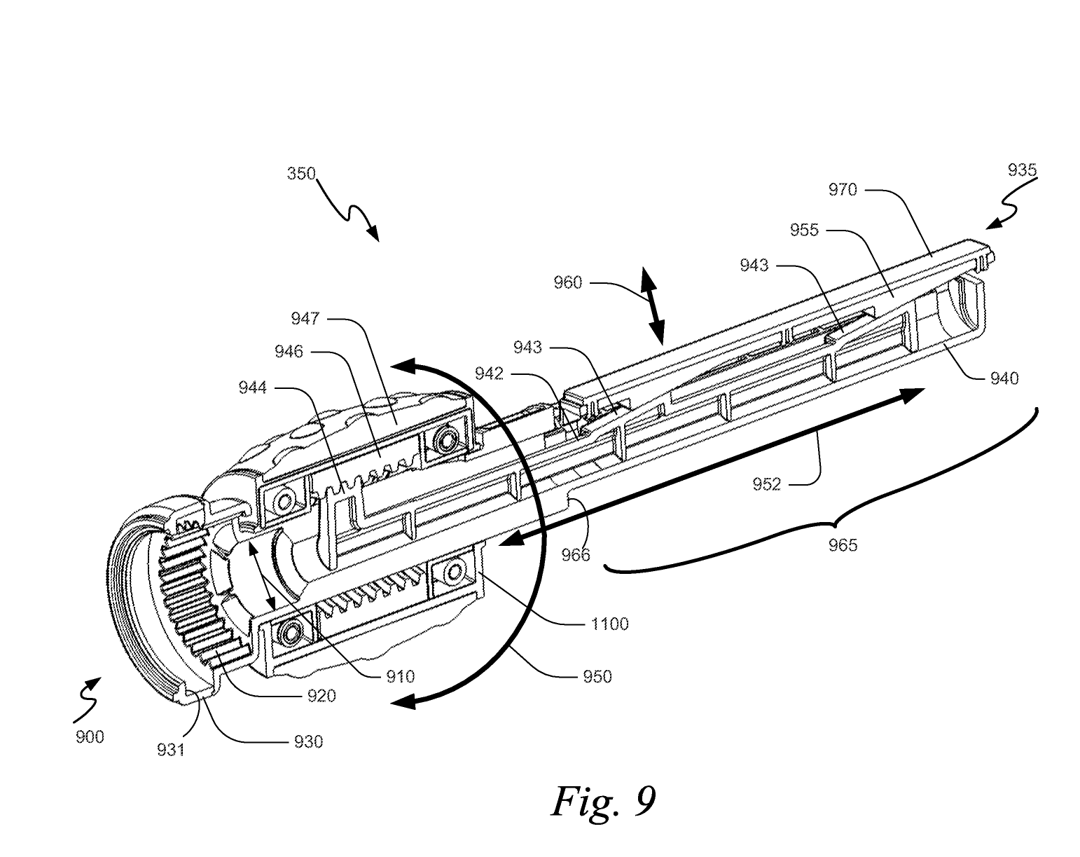

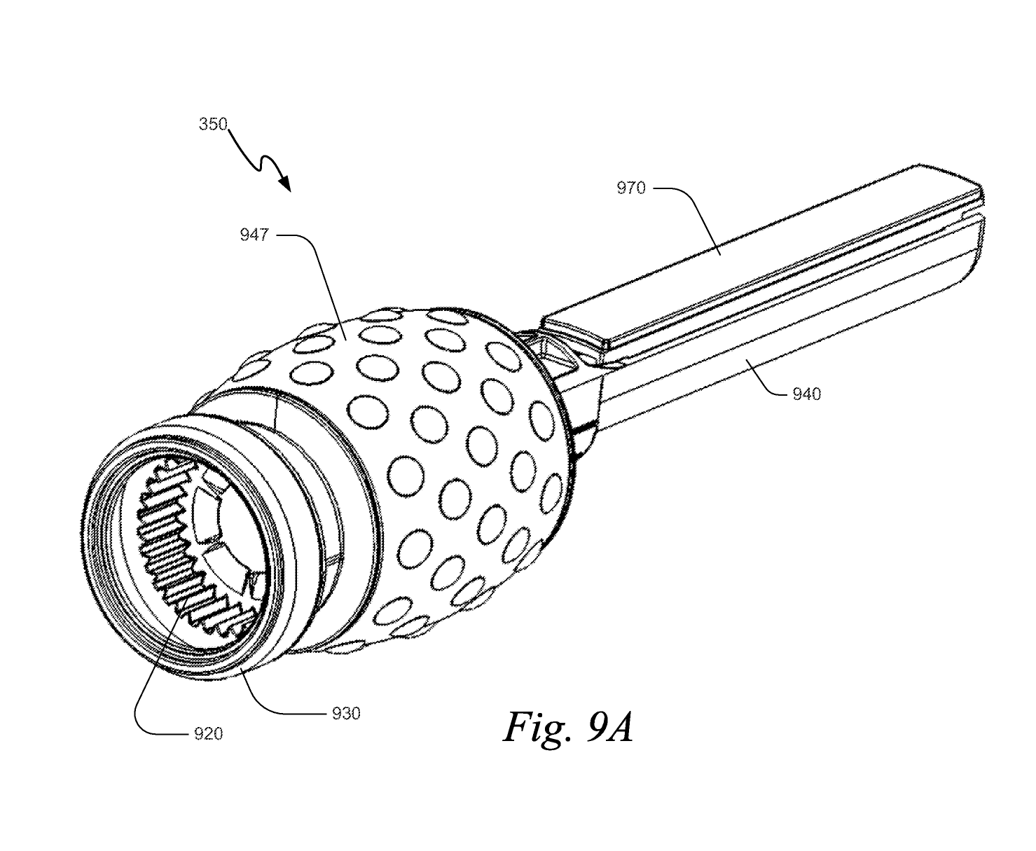

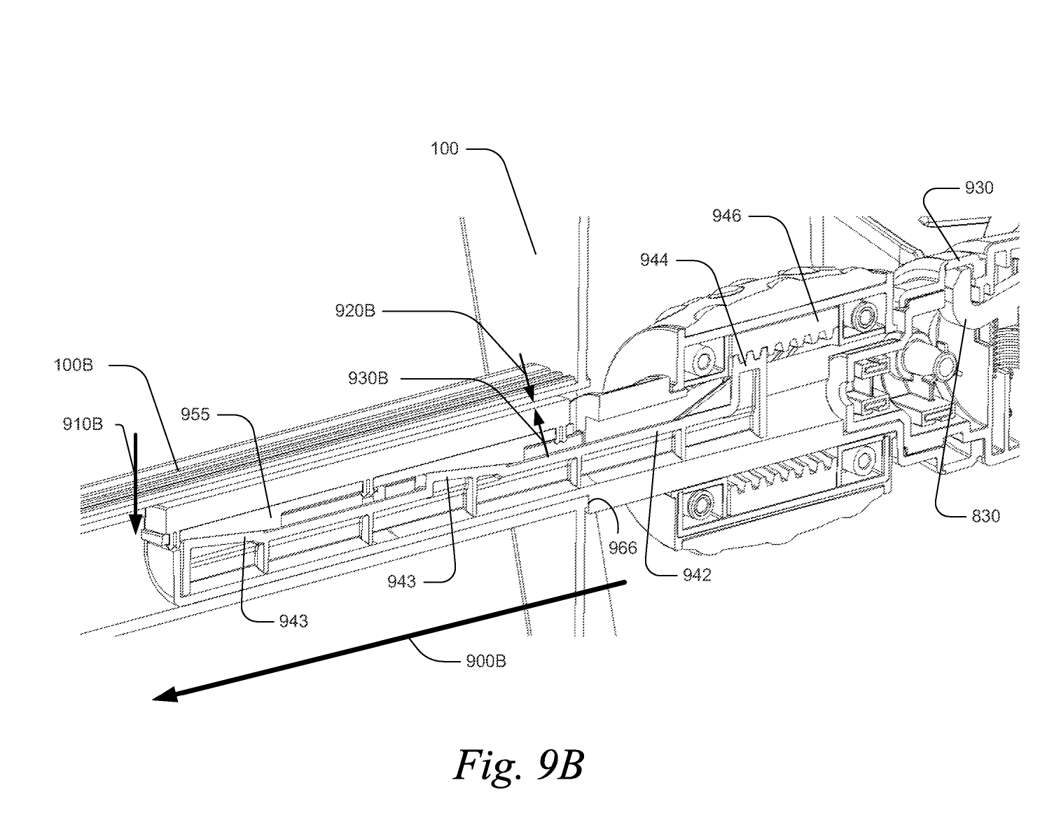

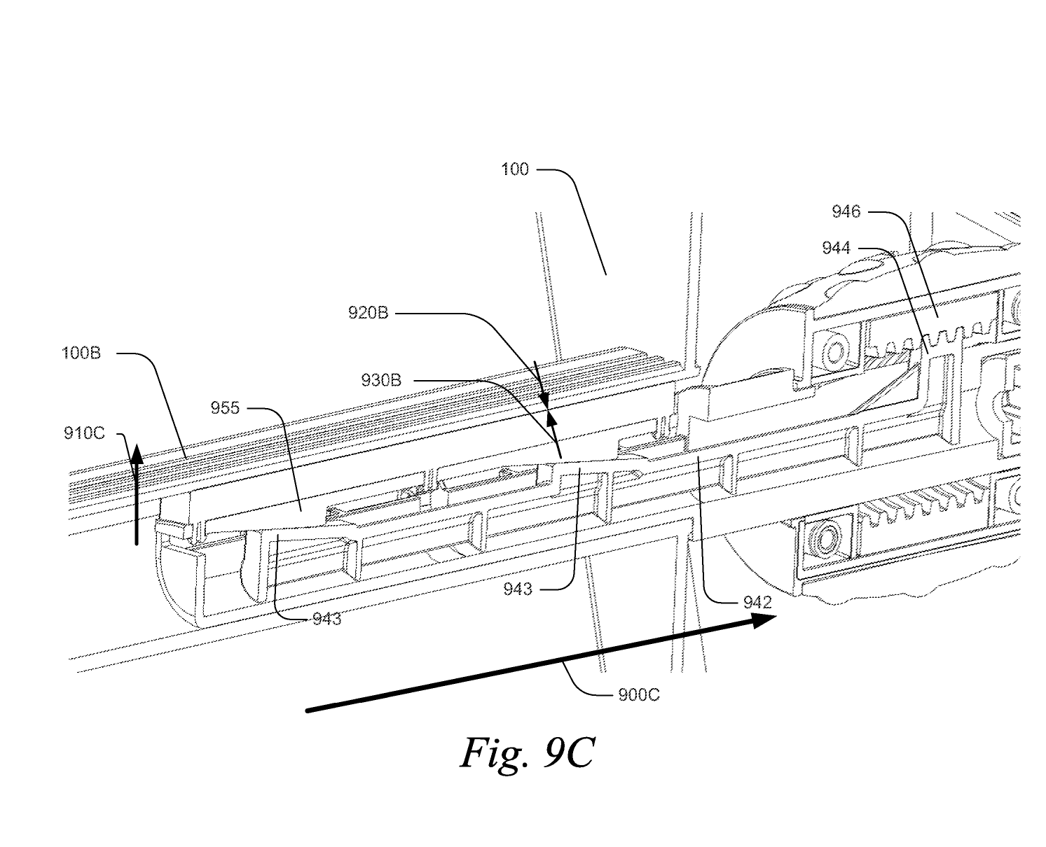

FIG. 8 illustrates another view of handle assembly 750, wherein the mechanical interface to the wedge rod assembly 350 is shown. FIG. 9 is also referred to in regards to the interface to the wedge rod assembly 350. The end of the handle assembly 750 that is distal from the support platform interface comprises approximately concentric cylinders 800, 810. The smaller diameter support cylinder 800 extends from the handle assembly 750 to act as an alignment and registration guide or post, so that when the handle assembly 750 is moved toward and into the cavity end 900 of wedge rod assembly 350 (opposite the direction shown in FIG. 4, 400), the support cylinder 800 aligns the central axes of the wedge rod assembly 350 and the handle assembly 750. Before being completely inserted into the wedge rod assembly cavity 900, the handle assembly 750 (and also with attached tray) may be rotated to a desired angle to accommodate the angle of the ladder with respect to vertical, or to perhaps induce a tilt in the platform so that paint within a paint bucket in the paint well 430 gathers together at a bottom corner of the bucket and/or allows easier viewablity by the user. Those of skill in the art also appreciate that such induced tilt in the bucket with respect to vertical assists with obtaining optimum paint coat on a brush, and minimal paint waste. After the handle assembly 750 is rotated to the correct angle, the cylinder end of the assembly is pushed further into the mating cavity 900, and registration vanes 820 engage registration teeth 920. The engagement of the registration vanes 820 with the registration teeth 920 prevents rotation of the tray assembly 300 once the tray assembly is engaged with a wedge assembly 350 that is locked in a ladder 100.

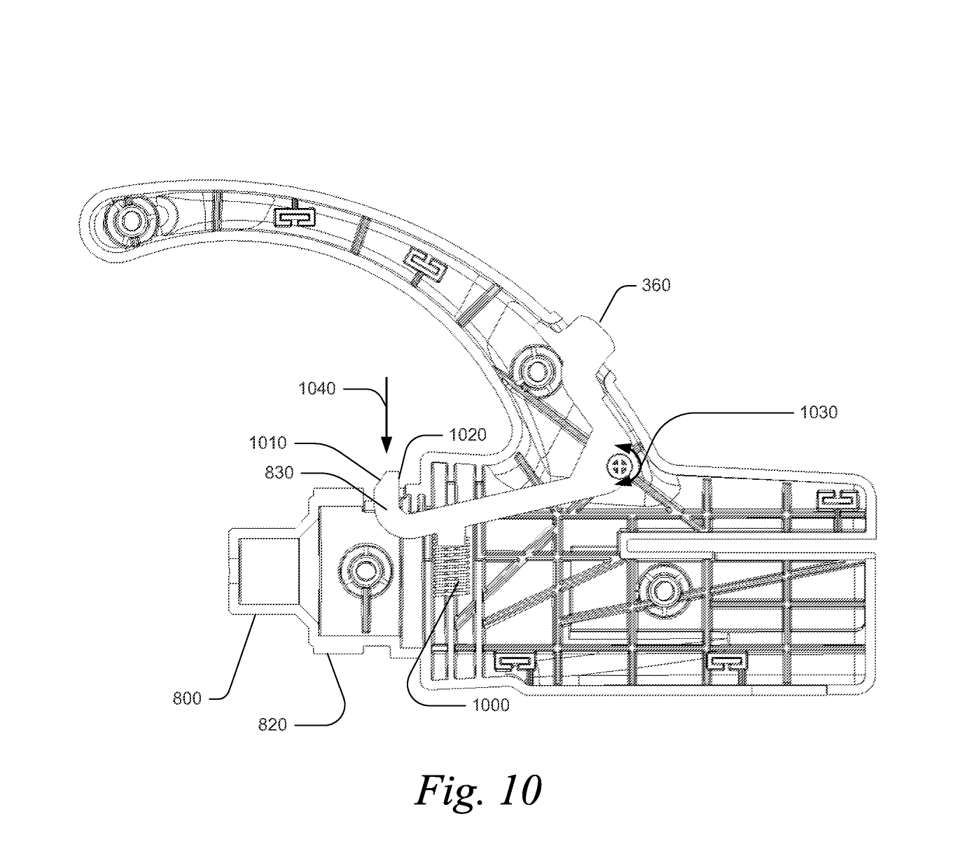

Directing the handle assembly 750 further into the wedge rod cavity 900 causes the latch 830 to engage with the edge of the outer surface of the wedge housing end cap 930. The force of the angular front surface (FIG. 10, 1010) of the latch 830 engaging the chamfered end cap 930 biases the latch downward 1040 into the handle assembly 750 (see cross sectional view in FIG. 10). The downward bias is opposed by force applied by spring 1000. As the movement into the cavity 900 continues, eventually the latch surface 1010 clears the inner wall of the wedge rod end cap 930, allowing the force applied by the spring 1000 to return the latch to an upward position. Once this occurs, the back surface 1020 of the latch is in communication with the inner side 931 of the end cap 930 that is secured to the housing 940, locking the handle assembly 750 (and thus the tray assembly 300, if attached to the handle assembly) to the wedge rod assembly 350. By depressing the integral button 360, the latch rotates about the pin axis 1030 opposing the force of the spring 1000, the back of the latch 1020 then sears from the inside of the end cap 930, and the handle assembly 750 may be released. Thus, the end cap 930 acts as both a cap for the wedge rod assembly 350 and a retaining/coupling ring for the handle assembly 750.

Those of skill in the art appreciate that the easy attachment and detachment of the tray assembly from the wedge rod assembly allows a person to easily carry a tray up and down a ladder with one hand, and either attach or detach the tray again with one hand. It can also be appreciated that once a wedge rod assembly 350 is installed in a rung of the ladder 100, different tray combinations may be attached to the ladder depending on the task at hand.

Returning to FIG. 9, a cross section of the wedge rod assembly 350 is shown. To appreciate the wedge rod assembly 350 fully assembled, an illustration is provided in FIG. 9A. The wedge rod assembly 350 provides the mechanical interface between the inside surface of the rung of the ladder 100 and the handle assembly 750, and allows a variety of trays to be attached to the ladder as described above. The rod assembly 350 comprises a cavity end 900 opposite a rung end 935. The rung arm 965 is typically inserted fully into a hollow rung of a ladder 100 until approximately halted by the detent notch 966 coming in proximity to the ladder 100. Inside of the wedge rod housing 940, a wedge rod 942 moves along the major axis 952 in response to turning 950 the collar grip 947 that couples the rotational force to a collar nut (or coupling nut) 946. On the surface of the collar grip 947 are traction enhancing features such as raised bumps (shown), raised ridges, formed voids, ridge patterns, parallel lines, or some combination of those features that help to increase friction between a person's hand and the collar grip 947. Teeth 944 on the wedge rod 942 engage the motion of the threads of the collar nut 946, translating the rotational motion 950 into lateral drive force 952. In turn, wedge ramps 943 move and slide against oppositely situated top ramps on wedge top 955, and as the major axial movement of the wedge top 955 is constrained by the wedge rod housing 940, the axial motion 952 of the wedge ramp 943 translates into an orthogonal displacement 960. It is this vertical displacement 960 that expands the effective thickness of the wedge rod assembly 350, locking it in place with a friction fit as wedge pad 970 contacts the inside of the hollow rung of a ladder 100. In one embodiment, the threads of collar nut 946 are so disposed that rotating the collar nut clockwise with respect to facing the ladder extends the wedge top 955, while a counterclockwise motion retracts the wedge top 955. Those of skill in the art appreciate that the threads could also be designed to provide the opposite drive response.

Turning to FIGS. 9B and 9C, a cross section of a wedge rod assembly 350 is shown installed in a ladder 100, also shown in section, further depicting the engagement between the wedge rod assembly and the interior surface of the rung. The rung arm in each case has been fully inserted into a rung 100B of a ladder 100, indicated by detent 966 contacting the ladder stile or rung opening. FIG. 9B illustrates the unengaged position; in this illustration the wedge rod 942 is fully extended 900B into the rung arm 965, since the collar nut 946 had been rotated to move wedge rod teeth 944 toward the rung end of the wedge rod assembly 350. Therefore wedge ramps 943 have allowed the top ramps of wedge top 955 to descend into the wedge rod housing, 910B, producing a gap between top of the pad 930B and the inside of the rung 920B. In FIG. 9C, the engaged position of the wedge rod assembly is shown in cross section. In this case, the collar nut 946 had been rotated to pull the wedge rod teeth 944 away from the center of the ladder 100, translating into drive in the outward direction 900C, causing the wedge ramps 943 to displace the ramps of the wedge top 955 vertically 910C. As the wedge top 955 has engaged the interior of the ladder rung, in this case there is no clearance between the top of the wedge pad 930B and the interior of the ladder rung 920B, thus a friction fit is formed between the wedge rod assembly and the lumen of the rung. As the wedge pad 970 may be comprised of an elastomeric material, force applied by the upward motion of the wedge top 955 may compress the pad 970 against the interior of the ladder rung 920B.

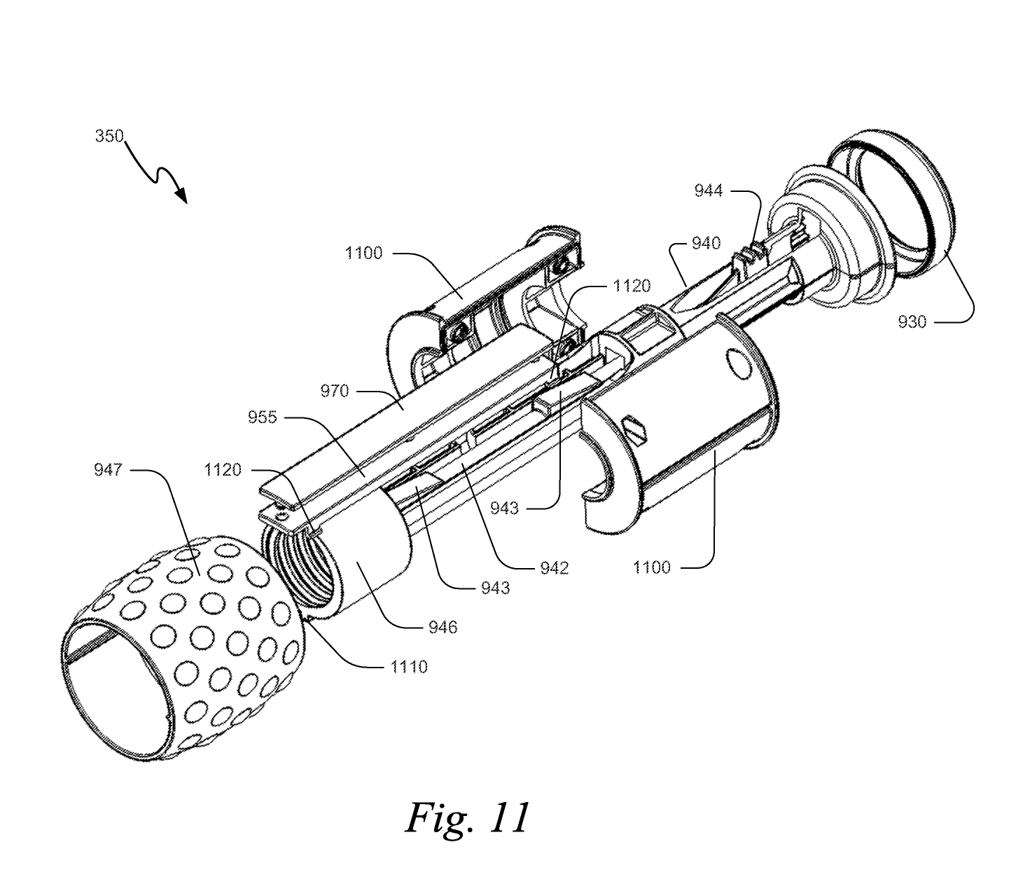

The wedge pad 970 may be bonded to the wedge top 955, and the entire wedge top assembly may be replaced with other wedge tops with varying pad thicknesses to accommodate different ladder interior rung dimensions. In a separate embodiment, wedge pads 970 snap onto wedge tops 955, allowing mechanical separation and interchangeability. In another embodiment, snap fit retainers (1120, FIG. 11) hold the wedge top 955 on the wedge rod assembly 350, but allow for vertical motion of the wedge top 955 while providing for interchangeability when sides of snap fit retainers 1120 are compressed to effectuate removal. Also, wedge pad 970 is typically an elastomeric material such as rubber, neoprene, or other TPE, providing an improved and motion-resistant friction grip between the wedge rod assembly 350 and the interior of the ladder rung. Those of skill in the art appreciate that the pitch of the collar nut threads, the wedge ramps and the top ramps are typically selected to cause the wedge rod to self-lock after rotational force is applied to the collar grip 947. Rotating the collar nut an opposite direction will cause retraction of the wedge top 955, releasing the wedge top 955 from the inside of the ladder rung and allowing its removal.

Turning to FIG. 11, a partially disassembled and exploded wedge rod assembly 350 is shown. The components and functions illustrated are as described above in regards to FIG. 9, but in this view, a collar nut housing 1100 is also shown in more detail. The two halves of collar nut housing 1100 surround collar nut 946 when the wedge rod 350 is fully assembled, and are typically either fused together, ultrasonically bonded together, or joined together via fasteners. Vanes on the collar nut 1110 engage with matching cavities in the collar nut housing 1100, entrapping the collar nut within the housing 1100 in a manner in which the collar nut 946 and the collar nut housing 1100 rotate in unison. Also when fully assembled, collar grip 947 grippingly engages the collar nut housing 1100, allowing rotational force to be coupled through the collar nut housing 1100 to the collar nut 946. As described above, when the wedge rod teeth 944 engage the rotating threads of the collar nut 146, rotational motion is translated to drive force along the vertical axis, which is translated by the wedge rod ramps 943 to the wedge top 955 ramps.

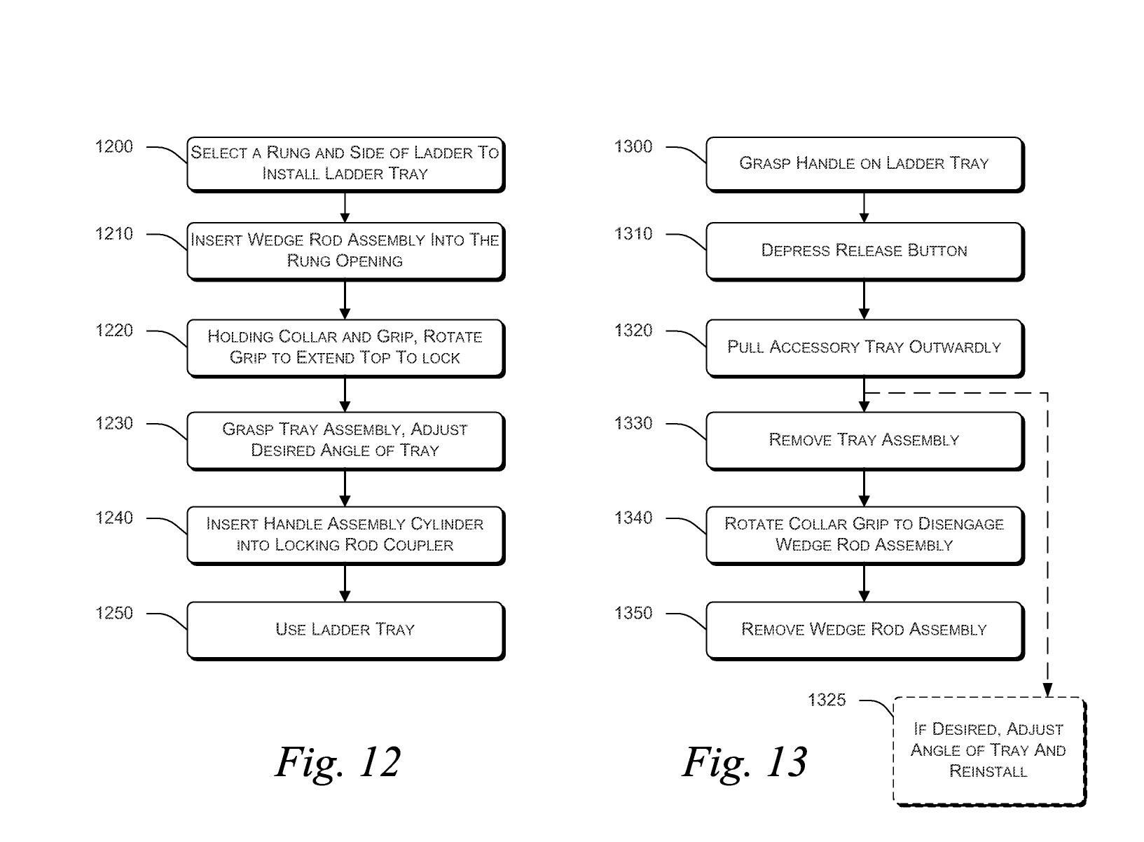

Turning to FIG. 12, a method of installing the ladder tray of the present invention is illustrated. First, 1200 a desired side of the ladder is selected, for instance if a worker is right-handed, the assembly may be installed on the right side. However, the present invention may be installed on either side of the ladder depending on the worker's preference, and the available space for the tray on the desired side. Also a rung height is selected 1200, which is determined by the height at which level that the worker wishes to use the ladder tray. Next, the wedge rod assembly is inserted 1210 into the lumen, or rung opening of the desired rung. Generally, the wedge rod is inserted fully until a detent position is reached, indicating it is fully ready for installation. Next, 1220 holding the collar or housing of the wedge rod assembly, the grip is rotated until the wedge rod assembly is locked into place and the grip no longer rotates. As an optional step (not shown) if the wedge rod assembly does not feel securely wedged in the ladder rung, the grip is turned the opposite direction to retract the grip pad, the wedge rod assembly is withdrawn from the rung, the grip pad and or rung top is interchanged with a thicker pad, and then the process of selecting, inserting, holding and rotating the grip are repeated until a suitable match is found. It may also be possible that a particular pad on the wedge top is too thick, in which case a thinner pad may be interchanged.

Once the wedge rod assembly is locked in place, the tray assembly is aligned with the wedge rod assembly, and the desired working angle of the tray is determined and obtained by rotating the tray 1230. A tray coupler on the tray assembly is inserted 1240 into a cavity in the locking rod assembly until the latch mechanism snaps into place. At that point, the user may test the connection by giving a gentle pull to the tray assembly, and if installed correctly, the tray should not detach without pressing the release button. Once the user is assured that the tray is properly installed, use may begin 1250. Optionally, as part of grasping the tray assembly 1230, a can of paint may be attached by its bucket bail wire to a hook on the bottom of the tray assembly, allowing paint and tray assembly to be more easily carried in a single hand.

Those of skill in the art recognize that it may also be possible to install a plurality of wedge rod assemblies in a plurality of rungs on one or more sides of a ladder, prior to step 1230. In this way, a user could easily move the tray assembly between rungs without having to use more than one hand, for instance.

Turning to FIG. 13, a method of removing and/or adjusting the ladder tray of the present invention is illustrated. First, the handle on the ladder tray assembly is grasped 1300, and the release button depressed 1310. While holding the handle, the user pulls outwardly 1320 on the tray assembly until the assembly clears the coupling cavity in the wedge rod assembly 1340. As an optional step, rather than fully removing the tray assembly, the tray assembly is partially withdrawn until the alignment vanes are free to allow the tray to rotate, and then a new use angle is selected and the tray reinstalled 1325. Such may be the case when a paint can is running low, or when the angle of the ladder with respect to vertical requires adjustment. Following the removal step 1330, the wedge rod assembly is removed 1340 by rotating the collar grip the opposite direction of installation, disengaging the wedge rod assembly. Finally, the wedge rod assembly is removed 1350 from the ladder rung.

An alternate embodiment of the present invention provides a utility tray and lockable support combination for attachment to a hollow-rung ladder comprising a locking assembly having an aperture end and an elongate locking end, wherein the locking assembly serves as a means for attaching the utility tray to the ladder; the elongate portion proximal to the elongate locking end thereof extends into a hollow rung in the ladder; a grip portion thereof proximal to the aperture end thereof is provided for locking the elongated portion thereof in the hollow rung, wherein a housing portion of the locking assembly is retained while the grip portion is rotated, the rotation translating a wedge pad to approximate an inside surface of the rung; and a coupling aperture is provided in the aperture end, the coupling aperture including a plurality of registration teeth; and, a coupling collar. The utility tray may include a support platform having a substantially planar top surface wherein the support platform includes a paint well having approximately cylindrical walls, a solid bottom surface attached thereto, and an open top area proximal to an opening in the support platform; a handle assembly having a tray interface end and a coupling end opposite the tray interface end. A registration post extends from the coupling end and is coaxial with a cylinder that includes one or more registration vanes; a pair of flanges is provided proximate to the interface end, the flanges interfacing with a top surface and a bottom surface of the support platform; and, a handle extends therefrom, the handle having an integrated release button interfaced to a release latch proximate to the registration post. The utility tray and lockable support combination so provided further comprises one or more tool storage orifices such as a circular tool holder, a slot tool holder, a brush tool holder, a screw driver holder, a putty knife holder, a scraper holder, a paintbrush holder, a knife holder, and combinations thereof. Also, the support platform further comprises an adjustable truss support, wherein the truss is attached to the support platform and paint well, and a T-bar adjustably is attached thereto. A grip portion further comprises a traction enhancing feature such as raised bumps, raised ridges, formed voids, ridge patterns, parallel lines, and combinations thereof.

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. For use with a ladder having a plurality of open rungs each defining a lumen, a paint bucket holder comprising:
a cantilever, a portion of which is adjustable to:
an open position thereof to make a friction fit within the lumen of one said open rung; and
a closed position thereof to at least partially eliminate the friction fit within the lumen of one said open rung; and,
a bucket holder projecting from the cantilever to bear the weight of a bucket.

2. The bucket holder of claim 1, wherein the bucket holder and the cantilever have connected and unconnected positions.

3. The bucket holder of claim 1, wherein the bucket holder and the cantilever have a handle for supporting the weight of the paint bucket holder.

4. The bucket holder as defined in claim 3, wherein the bucket holder and the cantilever have connected and unconnected positions thereof actuable via a release in the handle.

5. The bucket holder of claim 1, wherein the bucket holder has a support surface for the bottom of the bucket to bear the weight thereof.

6. The bucket holder of claim 5, wherein the bucket holder further comprises a wall extending above and connected to the support surface.

7. The bucket holder of claim 1, wherein the bucket holder comprises a catch for bearing the weight of the bucket at least partially through a bail of the bucket.

8. The bucket holder as defined in claim 7, wherein the bucket holder further comprises a support surface for the bottom of another said bucket to bear the weight thereof.

9. The bucket holder as defined in claim 8, wherein the bucket holder further comprises a wall extending above and connected to the support surface.

10. The bucket holder of claim 1, wherein the adjustable portion of the cantilever is adjusted between the open and closed positions thereof by movement of a component thereof.

11. The bucket holder of claim 1, wherein the adjustable portion of the cantilever is adjusted between the open and closed positions thereof by a member rotatable relative to the cantilever.

12. For use with a ladder having a plurality of open rungs each defining a lumen, a paint bucket holder comprising:
a cantilever, a portion of which is adjustable by rotating a member thereof relative to the cantilever to:
an open position thereof to make a friction fit within the lumen of one said open rung; and
a closed position thereof to at least partially eliminate the friction fit within the lumen of one said open rung;
a bucket holder projecting from the cantilever to bear the weight of a bucket; wherein:
bucket holder has handle for supporting the weight of the paint bucket holder; and,
the bucket holder and the cantilever have connected and unconnected positions thereof actuable via a release in the handle.

13. The bucket holder of claim 12, wherein the bucket holder has a support surface for the bottom of the bucket to bear the weight thereof.

14. The bucket holder of claim 13, wherein the bucket holder further comprises a wall extending above and connected to the support surface.

15. The bucket holder of claim 12, wherein the bucket holder comprises a catch for bearing the weight of the bucket at least partially through a bail of the bucket.

16. The bucket holder as defined in claim 15, wherein the bucket holder further comprises a support surface for the bottom of another said bucket to bear the weight thereof.

17. The bucket holder as defined in claim 16, wherein the bucket holder further comprises a wall extending above and connected to the support surface.

18. For use with a ladder having a plurality of open rungs each defining a lumen, a paint bucket holder comprising:
means for providing a cantilevered support for a bucket;
means for making a friction fit with an inside surface of an open rung; and,
means securing the cantilevered support means to the friction fit means.

19. The bucket holder as defined in claim 18, wherein the means for making a friction fit further comprises means to enlarge an elongated member to make a friction fit within the lumen of one said open rung.

20. The bucket holder as defined in claim 18, wherein the means for securing the cantilevered support means to the friction fit means comprises a latch means actuated by a handle.
